(19) United States
(12) Patent Application Publication
(10) Pub. No.: US 2016/0130173 A1
(43) Pub. Date: May 12, 2016

(54) OPTICAL FIBER GLASS BASE MATERIAL MANUFACTURING APPARATUS AND SINTERING METHOD

(71) Applicant: Shin-Etsu Chemical Co., Ltd., Tokyo (JP)

(72) Inventor: Kazuya UCHIDA, Ibaraki (JP)

(21) Appl. No.: 14/936,598

(22) Filed: Nov. 9, 2015

(30) Foreign Application Priority Data
Nov. 10, 2014 (JP) 2014-227683

(51) Int. Cl. C03B 37/014

(52) U.S. Cl. CPC C03B 37/0146; C03B 37/01446

(57) ABSTRACT

Provided is an optical fiber glass base material manufacturing apparatus, including a furnace core tube that houses a porous glass base material; a movement mechanism that moves the porous glass base material in a longitudinal direction thereof in the furnace core tube; a first heating section that heats and dehydrates the porous glass base material in the furnace core tube; and a second heating section that is arranged downstream from the first heating section in a movement direction of the porous glass base material, and sinters the porous glass base material by heating a portion of the porous glass base material in the longitudinal direction.

The contents of the following Japanese patent application are incorporated herein by reference:

NO. 2014-227683 filed on Nov. 10, 2014.

### BACKGROUND

1. Technical Field

The present invention relates to a manufacturing apparatus and a sintering method for a glass base material to be used for optical fiber.

2. Related Art

Manufacturing of an optical fiber glass base material includes forming a porous glass base material by depositing glass microparticles generated through hydrolysis. After this, the porous glass base material is heated and dehydrated in an atmosphere of inert gas and then the dehydrated porous glass base material is sintered through heating at a higher temperature. In this way, a transparent optical fiber glass base material is manufactured, as shown in Patent Document 1, for example.

Patent Document 1: Japanese Patent Application Publication No. 2010-189251

However, the method that includes passing the porous glass base material through a heater to achieve dehydration and passing the dehydrated porous glass base material through the heater again to achieve sintering after the porous glass base material has been drawn back through the heater requires a long time to move the porous glass base material, and this inhibits improvements to the producibility of the optical fiber glass base material.

### SUMMARY

According to a first aspect of the present invention, provided is an optical fiber glass base material manufacturing apparatus, comprising a furnace core tube that houses a porous glass base material; a movement mechanism that moves the porous glass base material in a longitudinal direction thereof in the furnace core tube; a first heating section that heats and dehydrates the porous glass base material in the furnace core tube; and a second heating section that is arranged downstream from the first heating section in a movement direction of the porous glass base material, and sinters the porous glass base material by heating a portion of the porous glass base material in the longitudinal direction.

According to a second aspect of the present invention, provided is an optical fiber glass base material manufacturing method, comprising housing a porous glass base material in a furnace core tube; heating and dehydrating the porous glass base material with a heating section surrounding the porous glass base material housed in the furnace core tube; and sintering an entire length of the porous glass base material by sequentially heating portions of the porous glass base material in the longitudinal direction while the porous glass base material is being moved, with a heater arranged downstream of the porous glass base material in the movement direction of the porous glass base material.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic structural view of an embodiment of the manufacturing apparatus 10 of the present invention used in the first embodiment.

FIG. 2 shows a relationship between the base material position and the heating temperature of the multistage heater in the first embodiment.

FIG. 3 shows a relationship between the base material position and the heating temperature of the multistage heater in the second embodiment.

FIG. 4 is a schematic structural view of the manufacturing apparatus 20 used in the third embodiment.

FIG. 5 shows a relationship between the base material position and the heating temperature of the multistage heater in the third embodiment.

FIG. 6 is a schematic structural view of the manufacturing apparatus 30 used in the comparative example.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

When manufacturing an optical fiber glass base material, first, using VAD or OVD, glass raw material is combusted in a flame to generate glass microparticles through hydrolysis. The generated glass microparticles are sequentially deposited on a rotating target rod in the axial direction or the radial direction to form a porous glass base material.

The porous glass base material is held by a support rod and hung into a furnace core tube. Furthermore, the porous glass base material is heated by a heater while being rotated and lowered through the inside of the furnace core tube. In this way, the porous glass base material is dehydrated and sintered inside the furnace core tube. When dehydrating the porous glass base material, inert gas necessary for dehydration is supplied from a gas supply nozzle provided in the lower portion of the furnace core tube, and gas is expelled from inside the furnace core tube through a gas exhaust tube provided in the upper portion of the furnace core tube.

When dehydrating the porous glass base material, the temperature of the heating region of the furnace core tube is set to be from 900° C. to 1300° C. When sintering the porous glass base material, the temperature of the heating region of the furnace core tube is set to be from 1400° C. to 1600° C.

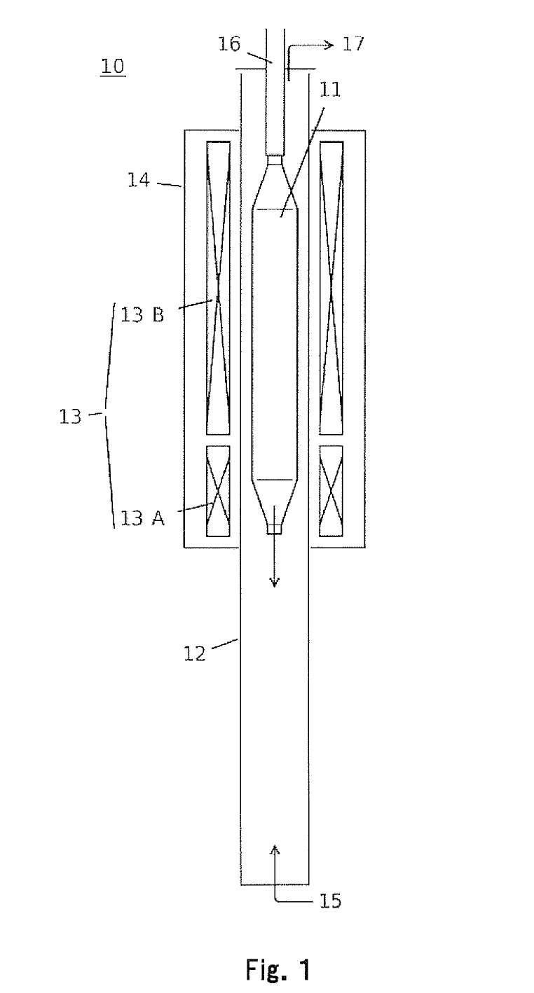

FIG. 1 schematically shows the structure of an optical fiber glass base material manufacturing apparatus 10 used for the dehydration process and sintering process performed on a porous glass base material such as described above. The manufacturing apparatus 10 in the drawing includes a cylindrical furnace core tube 12 made of quartz glass housing a porous glass base material 11, a multistage heater 13 in which the heaters are arranged along the longitudinal direction in a manner to surround the outer circumference of the furnace core tube 12, a furnace body 14 that houses the multistage heater 13, a gas induction opening 15 for introducing gas into the furnace core tube 12, a support rod 16 for supporting the porous glass base material 11, and a gas exhaust tube 17 for expelling the gas in the furnace core tube.

The multistage heater 13 is formed by a first heater 13A and a second heater 13B that are arranged along the longitudinal direction of the furnace core tube 12. Each heater is arranged to be able to be independently temperature controlled. The multistage heater 13 can form a heating region that is greater than or equal to the length of the porous glass base material, by having the total length of the multistage heater 13 be greater than or equal to the length of the porous glass base material. The number of stages in the multistage heater may be increased to reduce the cost of the apparatus, in consideration of the heater output, the power supply capacity, and the like. The following describes a method for manufacturing optical fiber glass base material by performing the dehydration process and the sintering process on the porous glass base material 11 using the manufacturing apparatus 10 shown in FIG. 1.

(Dehydration Process)

In the dehydration process, one end of the porous glass base material 11 is held by the support rod 16. The porous glass base material 11 is inserted into the furnace core tube 12, and a lid is placed on the furnace core tube 12. After this, the porous glass base material 11 is moved to a prescribed heating position and held at this heating position.

In the dehydration process, the multistage heater 13 increases the temperature in the furnace body 14 up to a prescribed temperature. The heating temperature realized by the multistage heater 13 is set to be a prescribed processing temperature for dehydrating the porous glass base material. The processing temperature is greater than or equal to 900° C. and less than or equal to 1300° C., for example.

In the dehydration process, the gas necessary for the dehydration process is supplied from the gas induction opening 15. The gas necessary for the dehydration process may be chlorine gas or a mixed gas containing chlorine gas and an inert gas such as He, Ar, or N₂. The internal pressure within the furnace core tube 12 during the dehydration process is set to be a positive pressure of approximately 10 Pa to 5000 Pa relative to the atmospheric pressure.

In the dehydration process, in the state described above, the porous glass base material 11 is rotated while being held in a heated state over a prescribed processing time. In this way, the dehydration process of the porous glass base material 11 is performed.

(Sintering Process)

The sintering process is performed after completion of the dehydration process. The temperature of the heater 13A in the furnace body 14 is increased to a temperature at which the porous glass base material 11 can be sintered, e.g. a temperature greater than or equal to 1400° C. and less than or equal to 1650° C. In the sintering process, the inert gas such as He or Ar is introduced from the gas induction opening 15. In the sintering process, the internal pressure of the furnace core tube 12 is set to be a positive pressure of approximately 10 Pa to 5000 Pa relative to the atmospheric pressure.

In the sintering process, the porous glass base material 11 is lowered into the furnace core tube 12 while being rotated around the center axis. In this way, the porous glass base material 11 is sequentially sintered from the bottom end thereof while the heating region of the porous glass base material 11 being heated by the heater 13A moves at a prescribed speed. As a result, the porous glass base material 11 becomes transparent optical fiber glass base material.

In the sintering process, the heating region of the heater 13A with a temperature from 1400° C. to 1650° C. may be shorter than the length of the porous glass base material 11. Furthermore, the sintering of the porous glass base material 11 may include transparent vitrification of the porous glass base material 11 as a result of gradual sintering from one end to the other end in the longitudinal direction of the porous glass base material 11 or from a central portion to an end portion in the longitudinal direction of the porous glass base material 11. By performing sintering in this manner, it is possible to form a gas escape opening within the porous glass base material 11 during the sintering process, and therefore gas bubbles in the optical fiber glass base material obtained after the sintering process can be reduced, resulting in a base material with high transparency.

In the sintering process, the remaining heater 13B may have its setting temperature lowered to conserve power. In the sintering process, the remaining heater 13B may have its temperature controlled to be a temperature that does not sinter the porous glass base material 11, i.e. a temperature less than 1400° C., and the porous portion that is not yet sintered may be preheated to encourage an increase of the sintering speed.

### First Embodiment

Using the manufacturing apparatus 10 of the porous glass base material shown in FIG. 1, optical fiber glass base material was manufactured by performing the dehydration process and the sintering process on a porous glass base material obtained through deposition on an outer circumference of a starter core material using OVD.

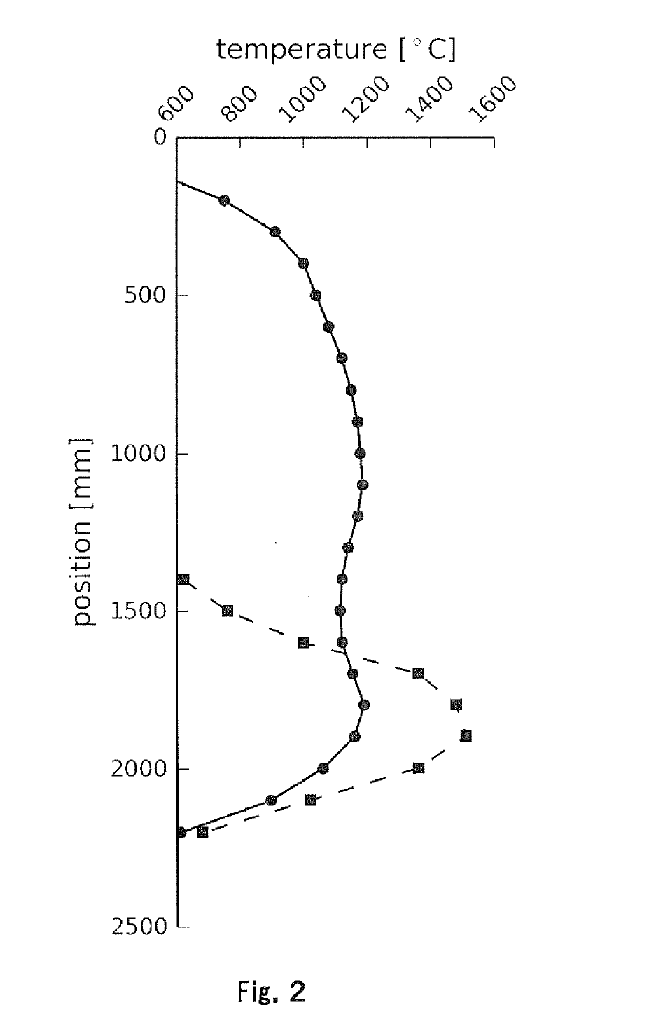

First, the porous glass base material 11 hanging from the support rod 16 was inserted from the opening at the top end of the furnace core tube 12, the porous glass base material 11 having a length in the axial direction of 1600 mm and including a tapered portion at each end with a length of 200 mm was moved to a position relative to the multistage heater 13, and a lid was placed on opening at the top end of the furnace core tube 12. Next, each heater forming the multistage heater 13 was set to a temperature of 1200° C. and the porous glass base material 11 was heated. The relationship between the heating temperature resulting from the multistage heater 13 at this time and the temperature at each position on the porous glass base material 11 is shown as the circles plotted to form the solid line in FIG. 2.

Here, the heaters 13A and 13B are each provided with a thermometer, and can be independently temperature controlled through PID control. The length of the heater 13A in the longitudinal direction of the furnace core tube is 400 mm, and the length of the heat generating portion, which excludes the electrode portions and the like, is 300 mm. The length of the heater 13B is 1300 mm, and the length of the heat generating portion, which excludes the electrode portions and the like, is 1200 mm.

The heaters 13A and 13B are arranged adjacently with an interval of approximately 50 mm therebetween, and are both housed in the furnace body 14. The total length of the multistage heater 13 is 1750 mm, and the heat generating portion spans 1650 mm from top to bottom. With this multistage heater 13, the length of the heating region in the furnace reaching a temperature of at least 900° C. is approximately 1800 mm, and therefore it is possible to heat and perform the dehydration process on the entire porous glass base material 11 at the same time.

In a state where the porous glass base material 11 was being held at the position described above, the porous glass base material 11 was rotated on the center axis at a speed of 5 rotations per minute. Chlorine gas with a flow rate of 0.5 liters per minute and He as the inert gas with a flow rate of 20 liters per minute were introduced from the gas induction opening 15, and the internal pressure of the furnace core tube 12 was held at a positive pressure of 10 Pa to 5000 Pa relative to the atmospheric pressure. In the heating region within the furnace core tube 12, the OH groups included in the porous glass base material 11 react chemically with the chlorine gas and enter into the atmospheric gas. The gas in which the OH groups have entered from the porous glass base material 11 is expelled to the outside of the furnace core tube 12 through the gas exhaust tube 17. The dehydration process described above continued for 90 minutes.

After this, the gas introduced from the gas induction opening 15 was changed to only He with a flow rate of 20 liters per minute and the setting temperature of the heater 13A was changed to 1560° C. The setting output of the heater 13B was set to zero. After the temperature of the heater 13A increased to the setting temperature, transparent vitrification was performed for the entire base material by rotating the porous glass base material 11 on the center axis at a speed of 5 revolutions per minute, moving the porous glass base material 11 downward at a speed of 10 mm per minute while introducing the He gas, and sintering from the bottom end to the top end of the base material.

The relationship between the temperature at each position in the longitudinal direction of the porous glass base material 11 in the above sintering process and the heating temperature of the multistage heater 13 is shown in FIG. 2 by the squares plotted to form the dashed line. As shown in the drawing, the heating region having at least a temperature need for sintering, i.e. a temperature of at least 1400° C., was approximately 250 mm.

### Second Embodiment

Using the manufacturing apparatus 10 shown in FIG. 1, optical fiber glass base material was manufactured by performing the dehydration process and the sintering process on a porous glass base material 11 obtained through deposition on an outer circumference of a starter core material using OVD. The length in the axial direction of the processed porous glass base material 11 was 1600 mm including a tapered portion at each end with a length of 200 mm.

After performing the dehydration process on the porous glass base material in the same manner as in the first embodiment, the gas introduced from the gas induction opening 15 was set to only He with a flow rate of 20 liters per minute, the setting temperature of the heater 13A was changed to 1560° C., and the setting temperature of the heater 13B was set to 1200° C., which is the same as the temperature used for the dehydration process. After the temperature of the heater 13A increased to the setting temperature, transparent vitrification was performed for the entire porous glass base material 11 by rotating the porous glass base material 11 on the center axis at a speed of 5 revolutions per minute, moving the porous glass base material 11 downward at a speed of 12 mm per minute while introducing the He gas, and sintering from the bottom end to the top end.

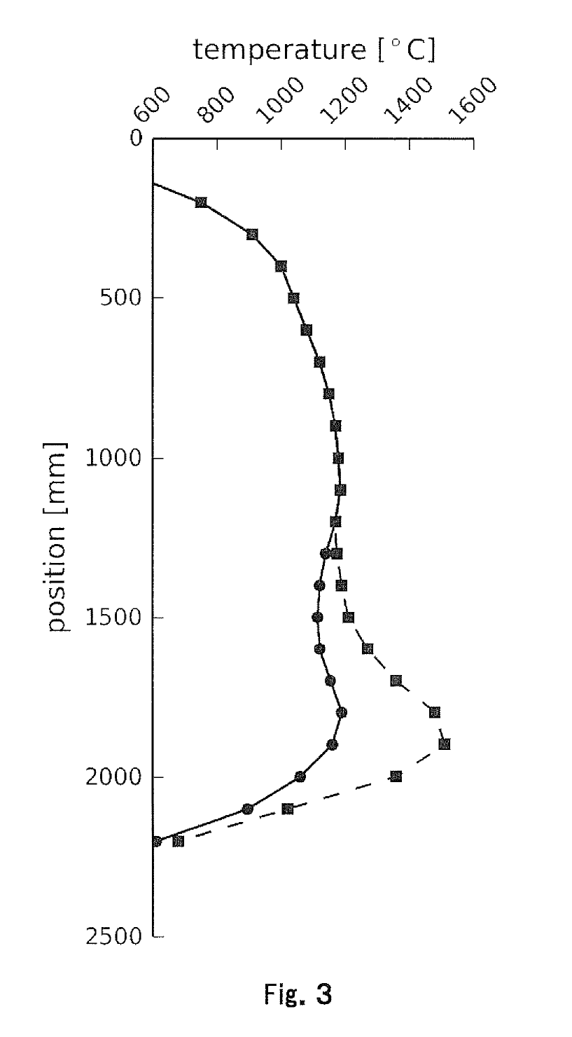

The relationship between the base material position at this time and the heating temperature of the multistage heater 13 is shown in FIG. 3 by the squares plotted to form the dashed line. The circles plotted to form the solid line in FIG. 3 indicate the relationship between the position in the longitudinal direction of the porous glass base material 11 during the dehydration process and the heating temperature of the multistage heater 13.

As shown in the drawing, the heating region having at least a temperature needed for sintering, i.e. a temperature of at least 1400° C., was approximately 250 mm. Furthermore, a preheated region with a temperature greater than or equal to 900° C. and a length of approximately 1400 mm was provided above the heater 13A, and therefore it was possible to obtain favorable glass base material without melt residue even though the movement speed of during the transparent vitrification was 12 mm per minute.

### Third Embodiment

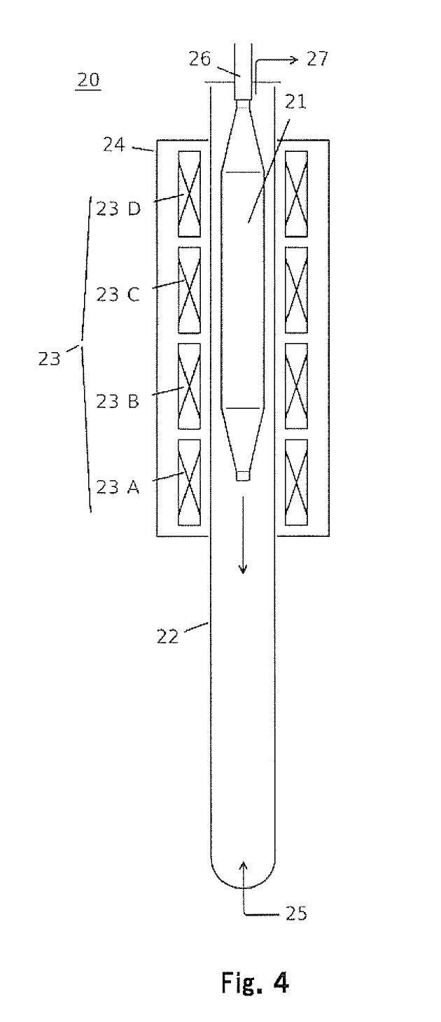

FIG. 4 schematically shows the structure of another manufacturing apparatus 20 for optical fiber glass base material. Using the manufacturing apparatus 20, optical fiber glass base material was manufactured by performing dehydration and sintering on a porous glass base material obtained through deposition on an outer circumference of a starting core base material through OVD.

The manufacturing apparatus 20 has a different structure from the manufacturing apparatus 10 shown in FIG. 1, in that the multistage heater 23 includes three or more heaters, which are the heaters 23A, 23B, 23C, and 23D, arranged along the longitudinal direction of the furnace core tube 22. The remaining structure of the manufacturing apparatus 20 is the same as that of the manufacturing apparatus 10 shown in FIG. 1, and therefore components of the manufacturing apparatus 20 are given reference numerals with the same last digit as corresponding components in the manufacturing apparatus 10, and redundant descriptions are omitted.

First, the dehydration process was performed using the manufacturing apparatus 20. The porous glass base material 21 hanging from the support rod 26 was inserted through the opening at the top end of the furnace core tube 22, and the porous glass base material 21 having a length in the axial direction of 1600 mm and including a tapered portion at each end with a length of 200 mm was moved to a position relative to the multistage heater 23 and held at this position. A lid was placed on the opening at the top end of the furnace core tube 22.

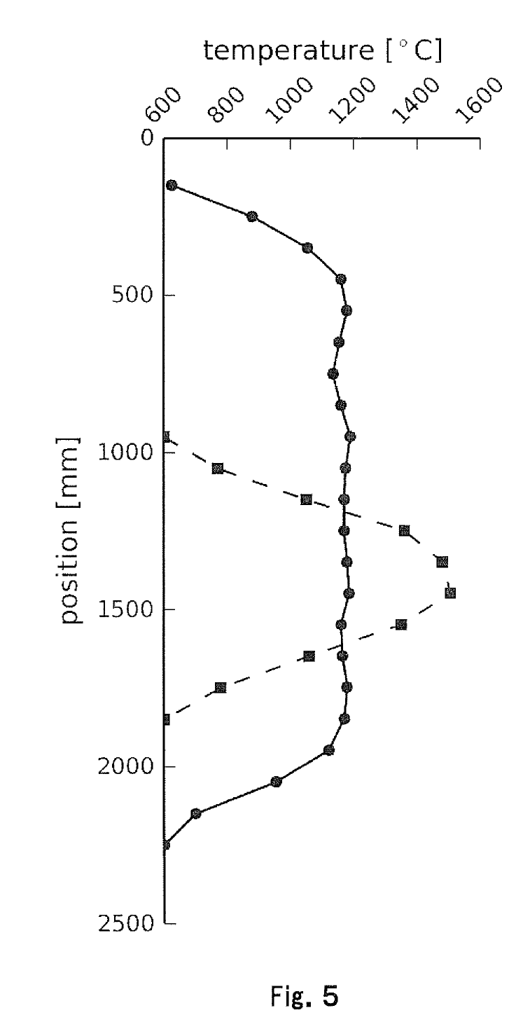

Next, the setting temperature of each heater forming the multistage heater 23 was increased to 1200° C. In the dehydration process, the relationship between the position in the longitudinal direction of the porous glass base material 21 and the heating temperature of the multistage heater 23 is shown by the circles plotted to form the solid line in FIG. 5.

The heaters 23A, 23B, 23C, and 23D are each provided with a thermometer, and can be independently temperature controlled through PID control. The length of each of the heaters 23A, 23B, 23C, and 23D in the longitudinal direction of the furnace core tube 22 is 400 mm, and the length of each heat generating portion, which excludes the electrode portions and the like, is 300 mm. Adjacent heaters have intervals therebetween of approximately 50 mm, and are all housed in a single furnace body 24. The total length of the multistage heater is 1750 mm, and the heat generating portion of the multistage heater spans 1650 mm from top to bottom.

As shown in FIG. 5, the heating region where the temperature is at least 900° C. has a length of approximately 1800 mm. Accordingly, the multistage heater 23 can heat and perform the dehydration process across the entire length of the porous glass base material 21 at the same time.

In the dehydration process, in a state where a position in the longitudinal direction of the porous glass base material 21 was being held at the position described above, the porous glass base material 21 was rotated on the center axis at a speed of 5 revolutions per minute. Chlorine gas with a flow rate of 0.5 liters per minute and He as the inert gas with a flow rate of 20 liters per minute were introduced from the gas induction opening 25, and the internal pressure of the furnace core tube 22 was held at a positive pressure of 10 Pa to 5000 Pa relative to the atmospheric pressure.

In the heating region within the furnace core tube 22, the OH groups included in the porous glass base material 21 react chemically with the chlorine gas and enter into the atmospheric gas. The gas in which the OH groups have entered from the porous glass base material 21 is expelled to the outside of the furnace core tube 22 through the gas exhaust tube 27. The dehydration process described above continued for 90 minutes.

After the dehydration process described above, the sintering process was performed on the porous glass base material 21. First, the gas being supplied from the gas induction opening 25 was changed to only He with a flow rate of 20 liters per minute and the setting temperature of the heater 23B was changed to 1560° C. The setting output for each of the other heaters 23A, 23C, and 23D was set to zero. The relationship between the position in the longitudinal direction of the porous glass base material 21 in this sintering process and the heating temperature of the multistage heater 23 is shown by the squares plotted to form a dashed line in FIG. 5.

As shown in the drawing, the heating region having at least a temperature needed for sintering, i.e. a temperature of at least 1400° C., was approximately 250 mm in the longitudinal direction of the porous glass base material 21. In the sintering process, after the temperature of the heater 23B increased to the setting temperature, transparent vitrification was performed in a range from the bottom portion to the top end of the base material by rotating the porous glass base material on the center axis at a speed of 5 revolutions per minute, moving the porous glass base material downward at a speed of 10 mm per minute while introducing the He gas, and sintering from the bottom portion to the top end of the base material.

The sintering of the tapered portion at the bottom end of the base material was incomplete and had melting residue. On the other hand, the trunk portion exhibited sufficient transparent vitrification, and no melting residue was seen.

### COMPARATIVE EXAMPLE

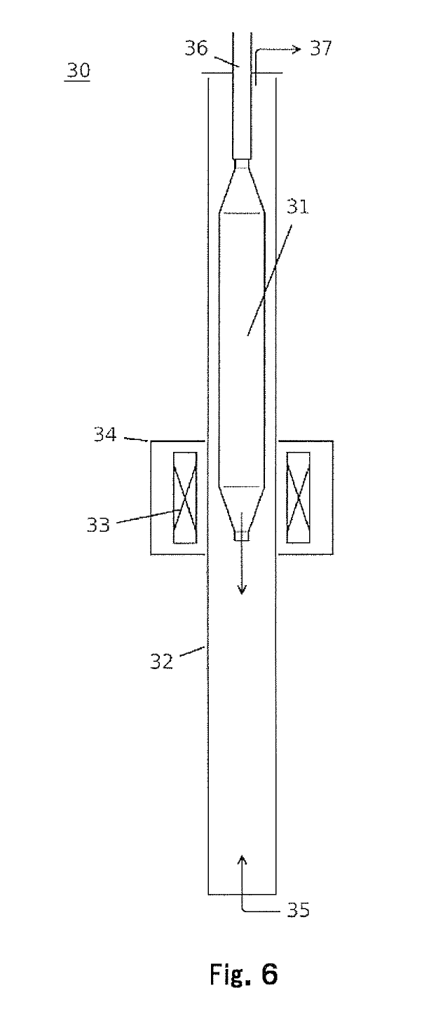

FIG. 6 schematically shows the structure of an optical fiber glass base material manufacturing apparatus 30 having a single heater, which a comparative example for comparison to the apparatus shown in FIG. 1. The structure of the manufacturing apparatus 30 differs from the structures of the manufacturing apparatus 10 shown in FIG. 1 and the manufacturing apparatus 20 shown in FIG. 2 by including a single heater 33. The remaining structure of the manufacturing apparatus 30 is the same as that of the manufacturing apparatus 10 and the manufacturing apparatus 20, and therefore components of the manufacturing apparatus 30 are given reference numerals with the same last digit as corresponding components in the manufacturing apparatus 10 and manufacturing apparatus 20, and redundant descriptions are omitted.

Using the manufacturing apparatus 30, optical fiber glass base material was manufactured by performing the dehydration process and the sintering process on a porous glass base material 31 obtained through deposition on a core rod using OVD. First, the porous glass base material 31 having a length in the axial direction of 1600 mm and including a tapered portion at each end with a length of 200 mm hanging from the support rod 36 was inserted through the opening at the top end of the furnace core tube 32, and the porous glass base material 31 was moved to a position relative to the heater 33 and held at this position. In this state, a lid was placed on the opening at the top end of the furnace core tube 32.

Next, the setting temperature of each heater forming the heater 33 was increased to 1200° C. The length of heater 33 in the longitudinal direction of the furnace core tube is 400 mm, and the length of the heat generating portion, which excludes the electrode portions and the like, is 300 mm. The heater 33 is housed in the furnace body 34. The heating region where the temperature is at least 900° C. has a length of approximately 250 mm.

Next, the porous glass base material 31 was moved downward at a speed of 10 mm per minute while being rotated on the center axis of the base material at a speed of 5 revolutions per minute. At this time, chlorine gas with a flow rate of 0.5 liters per minute and He as the inert gas with a flow rate of 20 liters per minute were introduced from the gas induction opening 35, and the internal pressure of the furnace core tube was held at a positive pressure of 10 Pa to 5000 Pa relative to the atmospheric pressure. In the heating region within the furnace core tube, the OH groups included in the porous glass react chemically with the chlorine gas and enter into the atmospheric gas. The gas in which the OH groups have entered from the porous glass base material is expelled to the outside of the furnace core tube through the gas exhaust tube 37. With this method, the dehydration process for the porous glass base material required 160 minutes.

After the dehydration process described above, the sintering process was performed on the porous glass base material 31. In the furnace core tube 32, the porous glass base material 31 was moved upward at a speed of 100 mm per minute, and the position of the porous glass base material 31 was returned to the position at the time when the dehydration process was started.

Next, the gas being supplied from the gas induction opening 35 was changed to only He with a flow rate of 20 liters per minute and the setting temperature of the heater 33 was changed to 1560° C. The heating region having at least a temperature needed for sintering, i.e. a temperature of at least 1400° C., was approximately 250 mm. After the temperature of the heater 33 increased to the setting temperature, the porous glass base material 31 was rotated on the center axis at a speed of 5 revolutions per minute and moved downward in the drawing at a speed of 10 mm per minute while introducing the He gas. As a result the porous glass base material 31 was sequentially sintered from the bottom end to the top end, until finally realizing transparent vitrification over the entire length of the porous glass base material 31.

In the manner described above, the comparative example using the manufacturing apparatus 30 including a single heater 33 required approximately twice as much time for the dehydration process as the first to third embodiments described above, and before beginning the dehydration process, time was also needed to raise the porous glass base material 31 to the original position.

As described above, the dehydration process and the sintering process include heating the porous glass base materials 11, 21, and 31 with different conditions. When performing the heating for the dehydration process, the time needed for the dehydration process can be shortened by heating the entire length of the porous glass base material 11 or 21 all at once. Furthermore, before the sintering process, no time is required to raise the porous glass base material 11 or 21, and therefore the time needed before beginning the sintering process can be shortened.

In this way, it is possible to shorten the time needed for the dehydration process and the sintering process, and to improve the throughput relating to the manufacturing of the optical fiber glass base material. Therefore, it is possible to improve the production efficiency of the optical fiber glass base material and reduce the manufacturing cost of the optical fiber glass base material.

What is claimed is:

1. An optical fiber glass base material manufacturing apparatus, comprising:
a furnace core tube that houses a porous glass base material;
a movement mechanism that moves the porous glass base material in a longitudinal direction thereof in the furnace core tube;
a first heating section that heats and dehydrates the porous glass base material in the furnace core tube; and
a second heating section that is arranged downstream from the first heating section in a movement direction of the porous glass base material, and sinters the porous glass base material by heating a portion of the porous glass base material in the longitudinal direction.

2. The optical fiber glass base material manufacturing apparatus according to claim 1, wherein
the first heating section and the second heating section can have heating temperatures thereof set independently from each other.

3. The optical fiber glass base material manufacturing apparatus according to claim 1, wherein
the first heating section has a total length that is greater than or equal to a total length of the porous glass base material.

4. The optical fiber glass base material manufacturing apparatus according to claim 1, wherein
the first heating section includes a plurality of heaters that are arranged along a longitudinal direction of the furnace core tube, each have a length less than a length of the porous glass base material, and can each have a heating temperature thereof set independently.

5. The optical fiber glass base material manufacturing apparatus according to claim 4, wherein
the plurality of heaters are arranged adjacently to each other in the longitudinal direction of the porous glass base material.

6. The optical fiber glass base material manufacturing apparatus according to claim 4, wherein
the second heating section shares at least one of the plurality of heaters forming the first heating section.

7. The optical fiber glass base material manufacturing apparatus according to claim 6, wherein
the second heating section is also used when dehydrating the porous glass base material.

8. An optical fiber glass base material manufacturing method, comprising:
housing a porous glass base material in a furnace core tube;
heating and dehydrating the porous glass base material with a heating section surrounding the porous glass base material housed in the furnace core tube; and
sintering an entire length of the porous glass base material by sequentially heating portions of the porous glass base material in the longitudinal direction while the porous glass base material is being moved, with a heater arranged downstream of the porous glass base material in the movement direction of the porous glass base material.

9. The optical fiber glass base material manufacturing method according to claim 8, wherein
the porous glass base material is heated and dehydrated by a first heating apparatus having a total length that is greater than or equal to a total length of the porous glass base material.

10. The optical fiber glass base material manufacturing method according to claim 9, wherein
the first heating apparatus includes a plurality of heaters that are arranged along a longitudinal direction of the furnace core tube, each have a length less than a length of the porous glass base material, and can each have a heating temperature thereof set independently.

11. The optical fiber glass base material manufacturing method according to claim 10, wherein
the porous glass base material is heated and dehydrated by a second heating section that shares at least one of the plurality of heaters.

12. The optical fiber glass base material manufacturing method according to claim 8, wherein
the porous glass base material is heated and dehydrated at a temperature that is greater than or equal to 900° C. and less than or equal to 1300° C.

13. The optical fiber glass base material manufacturing method according to claim 8, wherein
the porous glass base material is heated at a temperature that is greater than or equal to 1400° C. and less than or equal to 1650° C.
